(19) United States
(12) Patent Application Publication
(10) Pub. No.: US 2009/0091438 A1
(43) Pub. Date: Apr. 9, 2009

(54) SYSTEM AND METHOD OF PREVENTING INADVERTENT CHECK ENGINE TELLTALE

(75) Inventor: Christopher L. Rovik, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/869,163

(22) Filed: Oct. 9, 2007

(51) Int. Cl. B60Q 1/26

(52) U.S. Cl. 340/457; 116/28 R

(57) ABSTRACT

A system for preventing the illumination of a vehicle check engine light by notifying the driver that the fuel door is not closed. The system includes an interference member, a sensor for detecting the position of a fuel door, and a processor to communicate a detectable signal to the driver. The interference member prevents the fuel door from closing if the fuel cap is not properly seated in the fuel injection port, and the sensor detects the position of the door. The sensor can communicate the position of the door to the processor which in turn can send a detectable signal to the driver that the fuel door is ajar and the fuel cap is loose. Furthermore, in vehicles equipped with power slide doors, the processor can also disable the operation of the power slide door to prevent the power slide door from colliding with the fuel door.

### FIELD OF THE INVENTION

A system and method of eliminating the illumination of a vehicle's check engine light due to a loose fitting between a vehicle's fuel cap and a fuel injection port. More particularly, a system and method of notifying a driver that a vehicle's fuel cap may be loose because the fuel door is ajar using only one sensor.

### BACKGROUND OF THE INVENTION

Vehicles are typically equipped with a check engine light which notifies the driver that there may be a problem with the operation of the vehicle's engine. Such lights are illuminated when the vehicle's emission sensor determines that the engine may not be running in compliance with predetermined fuel emission standards. However, illumination may occur even when the engine is operating within predetermined emission standards because of a loose fuel cap. Currently, some vehicles are equipped with a sensor to detect the position of the fuel door, and some are equipped with a different sensor to determine if the fuel cap is loose. However, the addition of a second sensor increases vehicle manufacturing costs. Accordingly, it is desirable to have a system and method that can detect the position of a door and warn the driver that the fuel cap may be loose using only one sensor.

### SUMMARY OF THE INVENTION

A system and method of warning a driver that the fuel door is open and that the fuel cap may be loose utilizing a sensor, an interference member, and a processor. The interference member can be either a pad fixed to the interior of the fuel door, or a protruding member of a fuel cap such that the fuel door cannot close unless the fuel cap is properly seated in the fuel injection port. The sensor detects the position of the fuel door and communicates the fuel door position to the processor. If the fuel door is open and the vehicle is started, the processor provides the driver with a detectable signal that the fuel door is open and the fuel cap may be loose.

The system and method may also be used to control other vehicle features. For example, system and method may render a power slide door inoperable to prevent the power slide door from colliding with an open fuel door. This can be done two ways: 1) the sensor can communicate to the processor and the processor can control the power slide door as well as provide the driver with a detectable signal warning the driver that the fuel door is open and to check the fuel cap; or 2) the sensor can communicate directly with the power slide door and render it inoperable when the fuel door is open.

### BRIEF DESCRIPTION OF THE DRAWINGS

Advantages of the present invention will be readily appreciated as the same becomes better understood by reference to the following detailed description when considered in connection with the accompanying drawings, wherein:

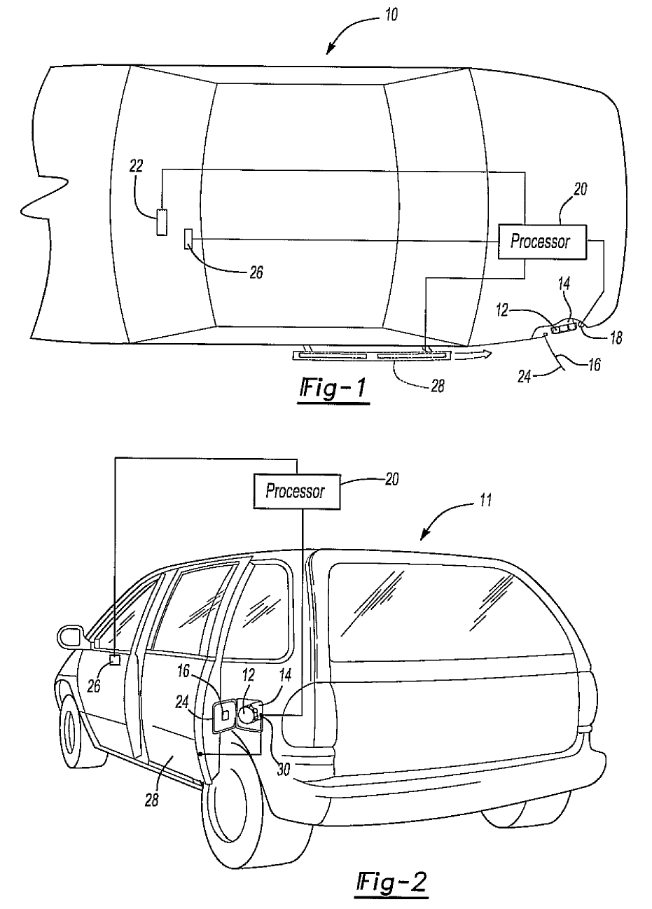

An embodiment of a system for detecting if a fuel cap is not properly seated in a fuel injection port of a vehicle having a sensor, a processor and an interference member where the processor sends a detectable signal to the driver, and controls the operation of a power slide door is shown in FIG. 1;

An alternative embodiment of a system for detecting if a fuel cap is not properly seated in a fuel injection port of a vehicle having a sensor, a processor, and an interference member where the sensor is in direct communication with a power slide door and the processor such that the sensor controls the operation of the power slide door and the processor notifies the driver of a loose fuel cap via a detectable signal is shown in FIG. 2;

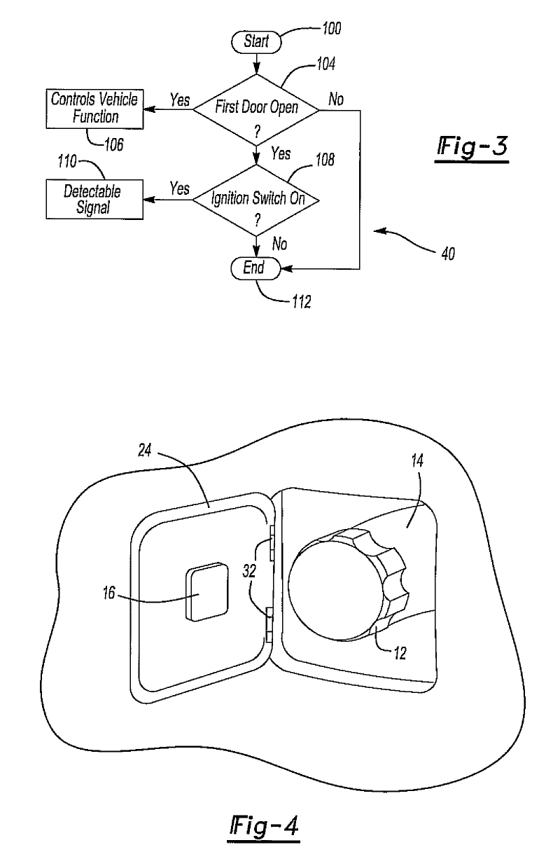

A method for warning a driver that the fuel cap may be loose using a sensor, a processor, and an interference member is shown in FIGS. 3;

An embodiment of an interference member that prevents a fuel door from closing if the fuel cap is not properly seated in a fuel injection port where the member is a pad fixed to the interior of a fuel door is shown in FIG. 4; and

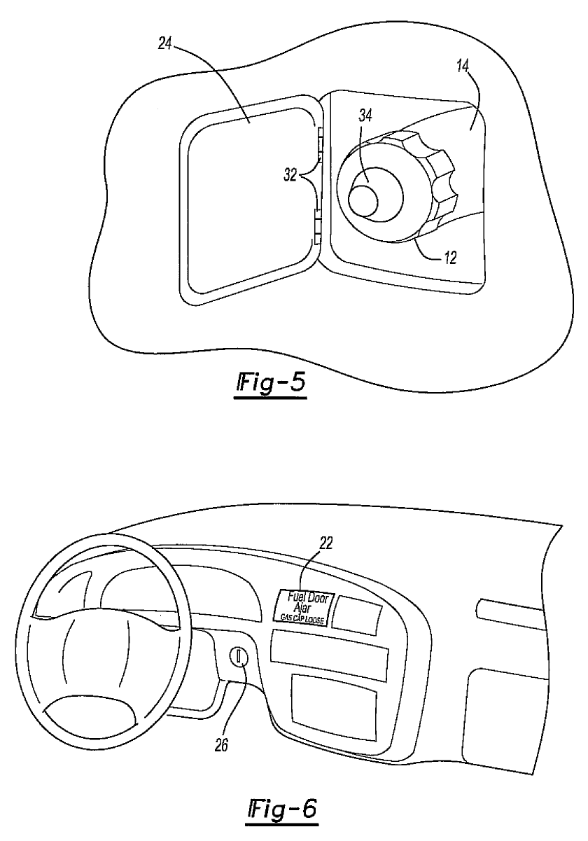

An alternative embodiment of an interference member that prevents a fuel door from closing if the fuel cap is not properly seated in a fuel injection port where the interference member is a protrusion of the fuel cap is shown in FIG. 5.

An embodiment of a textual display as part of a vehicle's GPS navigation screen, warning the driver that fuel door is ajar and the gas cap is loose is shown in FIG. 6.

### DETAILED DESCRIPTION OF THE PREFERRED EMBODIMENTS

An embodiment of a system for warning a driver that a fuel cap may not be properly seated in a fuel injection port of a vehicle having an interference member, a sensor, and a processor where the sensor communicates with the processor is shown in FIG. 1. The sensor 20 is positioned in the space between the fuel injection port 18 and a closed fuel door 14. The sensor 20 detects the position of the fuel door 14. The interference member 12 prevents the fuel door 14 from closing if the fuel cap 16 is not properly seated on the fuel injection port 18. The sensor 20 communicates the position of the fuel door 14 to the processor 22. If the ignition switch 24 is on, the processor 22 sends a detectable signal 28 to the driver that the fuel door 14 is ajar and to check the fuel cap 16. Additionally, the processor 22 may be able to control other vehicle functions, such as the operation of a power slide door 26, regardless of whether the ignition switch 24 is on or off.

An alternative embodiment of a system for warning a driver that a fuel cap may not be properly seated in a fuel injection port of a vehicle having an interference member 10, a sensor 19, and a processor 11 where the sensor 19 communicates with the processor 11 and a power slide door 25 is shown in FIG. 2. The sensor 19 is positioned in the space between the fuel injection port 17 and a closed fuel door 13. The sensor 19 detects the position of the fuel door 13. The interference member 10 prevents the fuel door 13 from closing if the fuel cap 15 is not properly seated on the fuel injection port 17. The sensor 19 detects and communicates the position of the fuel door 13 to the processor 11. If the vehicle ignition (not shown) is turned on and the fuel door 13 is open, the processor 11 sends a detectable signal 28 to the driver that the fuel door 13 is ajar and to check the fuel cap 15. Additionally, the sensor 19 communicates the position of the fuel door 13 directly to the power slide door 25 regardless of whether the vehicle ignition switch 28 is on or off. If the sensor 19 detects that the fuel door 13 is open, then the sensor 19 renders the power slide door 25 inoperable.

The sensor 19, 20 detects the position of the fuel door 13, 14, and communicates the position of the fuel door 13, 14 to the processor 11, 12. FIGS. 1 and 2 show the sensor 19, 20 positioned in the space between the fuel injection port 17, 18 and a closed fuel door 13, 14. However, the sensor 19, 20 can be positioned at other locations in the vehicle. The sensor 19, 20 is one known and used in the art such as a piezoelectric sensor, electromagnetic sensor, or a strain gauge. Accordingly, it will be appreciated to those skilled in the art that the sensor 19, 20 will be placed in accordance with the sensor's 19, 20 capabilities and requirements.

The processor 11, 22 is capable of controlling other vehicle outputs. For example, if the vehicle ignition 24 is turned on, the processor 11, 22 sends a textual display 28 warning that fuel door 13, 14 is open and that the fuel cap 15, 16 may be loose to the driver. Additionally, the processor 11, 22 can disable the operation of a power slide door 25, 26 if the fuel door 13, 14 is open, regardless of whether the ignition switch 24 is on. The processor 11, 22 is one known and used in the art.

The detectable signal 24 can be a textual display appearing on an instrument panel of a vehicle, or a text message appearing on a screen a navigation system as shown in FIG. 6. The detectable signal can also be a prerecorded message to the driver, that verbally warns the driver that the fuel door is open and to check the fuel cap.

A method of preventing the a vehicle check engine light from activating due to gasoline fumes escaping from a loose fuel cap while the vehicle engine is operating using a sensor is shown in FIG. 3. The methodology disclosed comprising preventing a fuel door from closing by having an interference member come into contact with a fuel cap when the fuel cap is not properly seated in the fuel injection port; detecting the position of the fuel door with a sensor; and warning a driver that the fuel door is open and to check the fuel cap if the vehicle ignition switch is on. The methodology begins at bubble 100 and progresses to decision block 104 where the sensor determines if the fuel door is open. If the fuel door is open, then the methodology ends at bubble 112. If the sensor detects that the fuel door is open, the methodology proceeds to block 108 where the processor having received a signal from the sensor that the fuel door is open, determines if the ignition switch is on. If the ignition switch is on, the methodology proceeds to block 110 where a detectable signal is delivered to the driver warning the driver that the fuel door is ajar and that the fuel cap may be loose. Additionally, the methodology may also proceed to block 106 if the sensor determines that the fuel door is open. In such cases, the sensor directly controls a vehicle function such as disabling the operation of a power slide door.

An embodiment of an interference member that prevents a fuel door from closing if the fuel cap is not properly seated in a fuel injection port is shown in FIG. 4. In this embodiment, the interference member is attached to the interior of a fuel door installed in a fuel injection port housing assembly. The fuel injection port housing assembly having an interference member 50, a fuel door 52, fuel cap 54, and fuel injection port 56. The fuel door is hinged 58 pivotably onto the body of the vehicle such that the fuel door 52 is flush with the vehicle body when closed. The fuel door 52 having an interior and exterior surface, and an interference member 50 shaped like a pad fixed to the interior surface of the fuel door 52. The fuel injection port 56 having a male portion for receiving a fuel cap 54. The fuel cap 54 when properly seated onto the fuel injection port 56 allows for the fuel door 52 fixed with the interference member 50 to close. However, the interference member 50 protrudes from the interior surface of the fuel door such that the interference member will come into contact with the exposed surface of the fuel cap 54. Thus, when the fuel cap 54 is not properly seated in the fuel injection port 56, thus preventing the fuel door 52 from closing.

An alternative embodiment of an interference member is shown in FIG. 5. in this embodiment, the interference member is a protrusion on the exterior of a fuel cap in a vehicle fuel injection port housing assembly. The vehicle fuel injection port housing assembly having an interference member 60, a fuel door 62, fuel cap 64, and fuel injection port 66. The fuel door is hinged 68 pivotably onto the body of the vehicle such that the fuel door is flush with the vehicle body when closed. The fuel door 62 having an interior and exterior surface. The fuel injection port 66 having a male portion for receiving a fuel cap 64. The fuel cap 64 having an interference member 60 protruding from the exterior surface of the fuel cap 64. The fuel cap 64 when properly seated onto the fuel injection port 66 allows for the fuel door 62 to close. The interference member 60 will come into contact with the fuel door 62, when the fuel cap 64 is not properly seated in the fuel injection port 66, thus preventing the fuel door 62 from closing.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A system for detecting if a fuel cap is not properly seated in a fuel injection port of a vehicle comprising:
an interference member to prevent the closure of a fuel door if the fuel cap is not properly seated in the fuel injection port;
a sensor operable to detecting the position of tie fuel door and communicating the position of the fuel door;
a processor in communication with the sensor and capable of providing a detectable signal to a driver of the vehicle indicating that the fuel cap is not properly seated.

2. A system as set forth in claim 1, wherein the sensor is in a fuel injection housing space within proximity to the fuel cap.

3. A system as set forth in claim 1, wherein the sensor may be a switch capable of disabling the operation of a power slide door when the switch detects that the fuel door is open.

4. A system as set forth in claim 1, wherein the processor is active when the vehicle's ignition switch is turned on.

5. A system as set forth in claim 4, wherein the processor can provide a detectable signal to the driver that the fuel door is open and that the fuel cap may not be properly seated on the fuel injection port.

6. A system as set forth in claim 5, wherein the detectable signal may be a textual display on a vehicle dashboard,

7. A system as set forth in claim 6, a pre-recorded verbal warning.

8. A system as set forth in claim 6, wherein the processor may also communicate to other parts of the vehicle that the fuel door is ajar.

9. A system as set forth in claim 8, wherein the processor upon receiving information from the sensor that the door is open may control an actuator to prevent the operation of a power slide door.

10. An interference member that prohibits a fuel door of a vehicle from closing when a fuel cap is not properly seated on a fuel injection port.

11. An interference member as set forth in claim 10, wherein the interference member is composed of a material such as hardened rubber, or a polymer.

12. An interference member as set forth in claim 10 wherein the interference member does not deform upon force to the extent the fuel door will not close if the fuel cap is not properly seated in the fuel injection port.

13. An interference member as set forth in claim 10 wherein the interference member is fixed to the interior of the fuel door.

14. An interference member as set forth in claim 10 wherein the interference member is a protrusion of a fuel cap.

15. A method of preventing the a vehicle check engine light from activating due to gasoline fumes escaping from a loose fuel cap while the vehicle engine is operating using only one sensor comprising:
preventing a fuel door from closing by having an interference member come into contact with a fuel cap when the fuel cap is not properly seated in the fuel injection port;
detecting the position of the fuel door with a sensor; and
warning a driver that the fuel door is open and to check the fuel cap if the vehicle ignition switch is on.

16. A method as set forth in claim 15 wherein the interference member prevents the fuel door from closing if the fuel cap is not properly seated in the fuel injection port.

17. A method as set forth in claim 15 wherein the interference member is a pad fixed to the interior of the fuel door and will not allow the fuel door to close if the fuel cap is not properly seated on the fuel injection port.

18. A method as set forth in claim 15 wherein the interference member is a protrusion of a fuel cap.

19. A method as set forth in claim 15 wherein the sensor detects the position of the fuel door and the sensor is in communication with the processor.

20. A method as set forth in claim 15 wherein the processor sends a detectable signal to the driver when the fuel door is open and the ignition switch is on.

21. A method as set forth in claim 15 wherein the detectable signal is a textual display notifying the driver that the fuel door is open and the fuel cap may be loose.

22. A method as set forth in claim 15 wherein the detectable signal is a prerecorded voice warning the driver that the fuel door is open and the fuel cap may be loose.

23. A method as set forth in claim 15 wherein the sensor may also be used to control other vehicle parts such as the operation of a power slide door.
